(19) United States
(12) Patent Application Publication
(10) Pub. No.: US 2020/0077287 A1
(43) Pub. Date: Mar. 5, 2020

(54) Apparatus, method and computer program

(71) Applicant: Nokia Technologies Oy, Espoo (FI)

(72) Inventors: Athul Prasad, Helsinki (FI); Mikko Saily, Laukkoski (FI); David Navratil, Helsinki (FI); Andreas Maeder, Wuerzburg (DE)

(73) Assignee: Nokia Technologies Oy

(21) Appl. No.: 16/116,217

(22) Filed: Aug. 29, 2018

(51) Int. Cl. H04W 24/10; H04L 12/18; H04W 24/08

(52) U.S. Cl. CPC H04W 24/10; H04W 24/08; H04L 12/189

(57) ABSTRACT

There is provided an apparatus, said apparatus including means for receiving, at a central unit of a base station, a measurement report from at least one user equipment receiving multicast traffic from a first distributed unit, wherein the measurement report includes at least one cell controlled by a second distributed unit and configuring, based on the measurement report, at least the first distributed unit and the second distributed unit with data transmission parameters for performing multi-cell point to multipoint transmission of multicast traffic.

### FIELD

The present application relates to a method, apparatus, system and computer program and in particular but not exclusively to enabling intra-gNB synchronised transmissions in a radio access network.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

In a first aspect there is provided an apparatus, said apparatus comprising means for receiving, at a central unit of a base station, a measurement report from at least one user equipment receiving multicast traffic from a first distributed unit, wherein the measurement report includes at least one cell controlled by a second distributed unit and configuring, based on the measurement report, at least the first distributed unit and the second distributed unit with data transmission parameters for performing multi-cell point to multipoint transmission of multicast traffic.

The apparatus may comprise means for receiving a traffic flow at the central unit of the base station and determining that the traffic flow is multicast traffic based on a QoS flow identifier or a multicast context associated with the traffic flow.

Means for configuring at least the first distributed unit and the second distributed unit may comprise means for adding, modifying or removing at least one of the first distributed unit and the second distributed unit from a list of distributed units for performing multi-cell point to multipoint transmission of multicast traffic.

The apparatus may comprise means for determining spectral efficiency of performing multi-cell point to multipoint transmission of multicast traffic using the second distributed unit and determining to configure the second distributed unit based on the determined spectral efficiency.

The apparatus may comprise means for receiving the data transmission parameters from the first distributed unit.

The data transmission parameters may include at least one of modulation and coding scheme, time and frequency scheduling information.

The apparatus may comprise means for receiving control transmission parameters from the first distributed unit and providing the control transmission parameters to the second distributed unit.

The control transmission parameters may comprise at least one of transmit power, reference signals and time and frequency allocation.

The apparatus may comprise means for configuring an interface between first distributed unit or the second distributed unit and a multicast functionality in the central unit.

The apparatus may comprise means for providing a context setup request to the second distributed unit.

The context setup request may be a UE context setup request or a multicast context request.

The apparatus may comprise means for providing a request to at least one of the first distributed unit and the second distributed unit to disable link adaptation.

The measurement report may be a radio resource control measurement report.

The measurement object of the measurement report may comprises signal strength.

In a second aspect, there is provided an apparatus, said apparatus comprising means for providing, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

The apparatus may comprise means for providing the data transmission parameters to the central unit.

The data transmission parameters may include at least one of modulation and coding scheme, time and frequency scheduling information.

The apparatus may comprise means for providing control transmission parameters to the central unit for providing to the second distributed unit.

The control transmission parameters may comprise at least one of transmit power, reference signals and time and frequency allocation.

The apparatus may comprised means for configuring an interface between the apparatus and a multicast functionality in the central unit.

The apparatus may comprise means for receiving a request from the central unit to disable link adaptation and causing link adaptation to be disabled.

The measurement report may be a radio resource control measurement report.

The measurement object of the measurement report may comprise signal strength.

In a third aspect there is provided an apparatus comprising at least one processor and at least one memory including a computer program code, the at least one memory and computer program code configured to, with the at least one processor, cause the apparatus at least to: receive, at a central unit of a base station, a measurement report from at least one user equipment receiving multicast traffic from a first distributed unit, wherein the measurement report includes at least one cell controlled by a second distributed unit and configure, based on the measurement report, at least the first distributed unit and the second distributed unit with data transmission parameters for performing multi-cell point to multipoint transmission of multicast traffic.

The apparatus may be configured to receive a traffic flow at the central unit of the base station and determine that the traffic flow is multicast traffic based on a QoS flow identifier or a multicast context associated with the traffic flow.

The apparatus may be configured to add, modify or remove at least one of the first distributed unit and the second distributed unitfrom a list of distributed units for performing multi-cell point to multipoint transmission of multicast traffic.

The apparatus may be configured to determine spectral efficiency of performing multi-cell point to multipoint transmission of multicast traffic using the second distributed unit and determine to configure the second distributed unit based on the determined spectral efficiency.

The apparatus may be configured to receive the data transmission parameters from the first distributed unit.

The data transmission parameters may include at least one of modulation and coding scheme, time and frequency scheduling information.

The apparatus may be configured to receive control transmission parameters from the first distributed unit and providing the control transmission parameters to the second distributed unit.

The control transmission parameters may comprise at least one of transmit power, reference signals and time and frequency allocation.

The apparatus may be configured to configure an interface between first distributed unit or the second distributed unit and a multicast functionality in the central unit.

The apparatus may be configured to provide a context setup request to the second distributed unit.

The context setup request may be a UE context setup request or a multicast context request.

The apparatus may be configured to provide a request to at least one of the first distributed unit and the second distributed unit to disable link adaptation.

The measurement report may be a radio resource control measurement report.

The measurement object of the measurement report may comprises signal strength.

In a fourth aspect there is provided an apparatus comprising: at least one processor and at least one memory including a computer program code, the at least one memory and computer program code configured to, with the at least one processor, cause the apparatus at least to: provide, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

The apparatus may be configured to provide the data transmission parameters to the central unit.

The data transmission parameters may include at least one of modulation and coding scheme, time and frequency scheduling information.

The apparatus may be configured to provide control transmission parameters to the central unit for providing to the second distributed unit.

The control transmission parameters may comprise at least one of transmit power, reference signals and time and frequency allocation.

The apparatus may be configured to configure an interface between the apparatus and a multicast functionality in the central unit.

The apparatus may be configured to receive a request from the central unit to disable link adaptation and causing link adaptation to be disabled.

The measurement report may be a radio resource control measurement report.

The measurement object of the measurement report may comprise signal strength.

In a fifth aspect there is provided a method comprising receiving, at a central unit of a base station, a measurement report from at least one user equipment receiving multicast traffic from a first distributed unit, wherein the measurement report includes at least one cell controlled by a second distributed unit and configuring, based on the measurement report, at least the first distributed unit and the second distributed unit with data transmission parameters for performing multi-cell point to multipoint transmission of multicast traffic.

The method may comprise receiving a traffic flow at the central unit of the base station and determining that the traffic flow is multicast traffic based on a QoS flow identifier or a multicast context associated with the traffic flow.

Configuring at least the first distributed unit and the second distributed unit may comprise adding, modifying or removing at least one of the first distributed unit and the second distributed unit from a list of distributed units for performing multi-cell point to multipoint transmission of multicast traffic.

The method may comprise determining spectral efficiency of performing multi-cell point to multipoint transmission of multicast traffic using the second distributed unit and determining to configure the second distributed unit based on the determined spectral efficiency.

The method may comprise receiving the data transmission parameters from the first distributed unit.

The data transmission parameters may include at least one of modulation and coding scheme, time and frequency scheduling information.

The method may comprise receiving control transmission parameters from the first distributed unit and providing the control transmission parameters to the second distributed unit.

The control transmission parameters may comprise at least one of transmit power, reference signals and time and frequency allocation.

The method may comprise configuring an interface between first distributed unit or the second distributed unit and a multicast functionality in the central unit.

The method may comprise providing a context setup request to the second distributed unit.

The context setup request may be a UE context setup request or a multicast context request.

The method may comprise providing a request to at least one of the first distributed unit and the second distributed unit to disable link adaptation.

The measurement report may be a radio resource control measurement report.

The measurement object of the measurement report may comprises signal strength.

In a sixth aspect there is provided a method comprising providing, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

The method may comprise providing the data transmission parameters to the central unit.

The data transmission parameters may include at least one of modulation and coding scheme, time and frequency scheduling information.

The method may comprise providing control transmission parameters to the central unit for providing to the second distributed unit.

The control transmission parameters may comprise at least one of transmit power, reference signals and time and frequency allocation.

The method may comprise configuring an interface between the apparatus and a multicast functionality in the central unit.

The method may comprise receiving a request from the central unit to disable link adaptation and causing link adaptation to be disabled.

The measurement report may be a radio resource control measurement report.

The measurement object of the measurement report may comprise signal strength.

In a seventh aspect there is provided a computer readable medium comprising program instructions for causing an apparatus to perform at least the following receiving, at a central unit of a base station, a measurement report from at least one user equipment receiving multicast traffic from a first distributed unit, wherein the measurement report includes at least one cell controlled by a second distributed unit and configuring, based on the measurement report, at least the first distributed unit and the second distributed unit with data transmission parameters for performing multi-cell point to multipoint transmission of multicast traffic.

The apparatus may be caused to perform receiving a traffic flow at the central unit of the base station and determining that the traffic flow is multicast traffic based on a QoS flow identifier or a multicast context associated with the traffic flow.

The apparatus may be caused to perform adding, modifying or removing at least one of the first distributed unit and the second distributed unit from a list of distributed units for performing multi-cell point to multipoint transmission of multicast traffic.

The apparatus may be caused to perform determining spectral efficiency of performing multi-cell point to multipoint transmission of multicast traffic using the second distributed unit and determining to configure the second distributed unit based on the determined spectral efficiency.

The apparatus may be caused to perform receiving the data transmission parameters from the first distributed unit.

The data transmission parameters may include at least one of modulation and coding scheme, time and frequency scheduling information.

The apparatus may be caused to perform receiving control transmission parameters from the first distributed unit and providing the control transmission parameters to the second distributed unit.

The control transmission parameters may comprise at least one of transmit power, reference signals and time and frequency allocation.

The apparatus may be caused to perform configuring an interface between first distributed unit or the second distributed unit and a multicast functionality in the central unit.

The apparatus may be caused to perform providing a context setup request to the second distributed unit.

The context setup request may be a UE context setup request or a multicast context request.

The apparatus may be caused to perform providing a request to at least one of the first distributed unit and the second distributed unit to disable link adaptation.

The measurement report may be a radio resource control measurement report.

The measurement object of the measurement report may comprises signal strength.

In an eighth aspect there is provided a computer readable medium comprising program instructions for causing an apparatus to perform at least the following providing, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

The apparatus may be caused to perform providing the data transmission parameters to the central unit.

The data transmission parameters may include at least one of modulation and coding scheme, time and frequency scheduling information.

The apparatus may be caused to perform providing control transmission parameters to the central unit for providing to the second distributed unit.

The control transmission parameters may comprise at least one of transmit power, reference signals and time and frequency allocation.

The apparatus may be caused to perform configuring an interface between the apparatus and a multicast functionality in the central unit.

The apparatus may be caused to perform receiving a request from the central unit to disable link adaptation and causing link adaptation to be disabled.

The measurement report may be a radio resource control measurement report.

The measurement object of the measurement report may comprise signal strength.

In a ninth aspect there is provided a non-transitory computer readable medium comprising program instructions for causing an apparatus to perform a method according to the fifth or sixth aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 shows a schematic diagram of LTE Architecture;

FIG. 5 shows a schematic diagram of NG-RAN architecture;

FIG. 6 shows a 5G multicast/broadcast architecture for content delivery:

FIG. 7 shows a flowchart of a method according to one example;

FIG. 8 shows a schematic diagram of NG-RAN architecture according to an embodiment;

FIG. 9 shows a signalling flow according to an embodiment;

FIG. 10 shows a signalling flow according to an embodiment;

FIG. 11 shows a signalling flow according to an embodiment.

### DETAILED DESCRIPTION

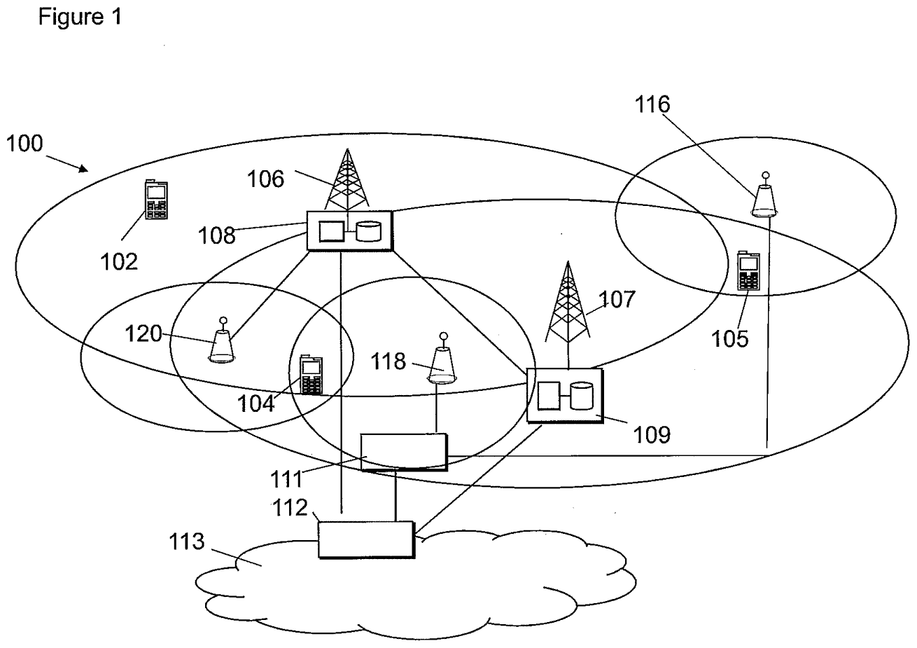

Before explaining in detail the examples, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatuses. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-advanced. Base stations of NR systems may be known as next generation Node Bs (gNBs). Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. NR may use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UE(s) exchanging traffic with the DN.

The UPF is controlled by an SMF (Session Management Function) that receives policies from a PCF (Policy Control Function). The CN may also include an AMF (Access & Mobility Function).

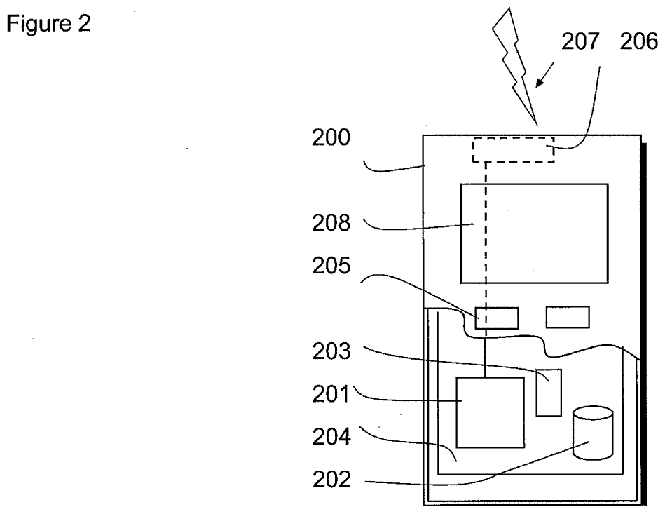

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

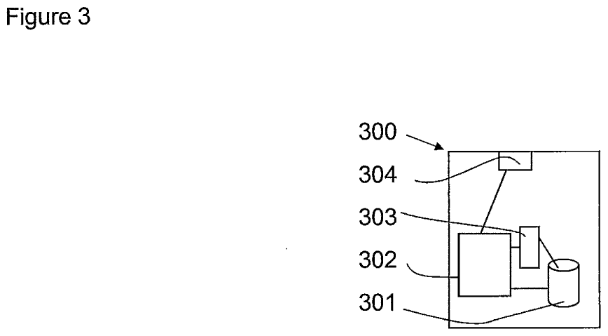

FIG. 3 shows an example of a control apparatus for a communication system, for example to be coupled to and/or for controlling a station of an access system, such as a RAN node, e.g. a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

Multicast and Broadcast networks under the umbrella of Multimedia Broadcast/Multicast Service (MBMS) has been a key component in 3G and 4G LTE-Advanced wireless networks. MBMS may enable resource efficient content distribution. The content may comprise, e.g. TV broadcasts or public safety broadcasts (e.g. public warning systems and mission critical communication systems) in legacy broadband networks.

Due to the increase in the content quality requirements and/or time criticality, the amount of radio resources consumed for delivering content has increased with the passage of time. The content quality requirements increase with advanced video and audio codecs enhancing the quality of experience of the end users. Network operators allocate higher amount of radio resources to efficiently and effectively deliver this content to the end user. The scarce amount of available spectral resources may make such content delivery over the air, increasingly challenging. MBMS can reduce the amount of radio resources needed for delivering the media content when the media content is broadcasted to multiple mobile devices over a wide area.

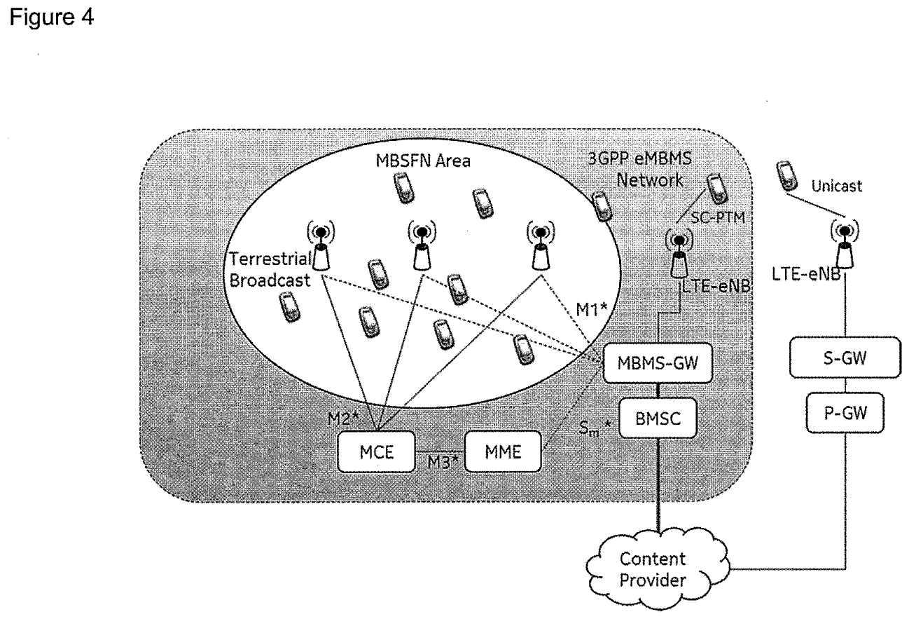

An overview of the LTE architecture for MBSFN, SC-PTM and unicast is shown in FIG. 4. There are separate user-plane paths for multicast/broadcast (through Broadcast Multicast—Service Center (BM-SC) and MBMS—Gateway (MBMS-GW)) and unicast (through Packet Data Network—Gateway (P-GW) and Serving—Gateway (S-GW)) in LTE. The timing for the OTA transmissions using SYNC protocol data units (PDUs) is currently done at the root of the core network in the BM-SC.

Multicast/broadcast single frequency networks (MBSFN) may be used to improve spectral efficiency with multicast/broadcast transmissions in LTE. MBSFN send synchronized transmissions from multicast base stations with over-the-air (OTA) transmissions of the data packet. The OTA transmissions (i.e. configuration of MCS, subframes etc.) are coordinated by a Multi-cell/multicast Coordination Entity (MCE). The content synchronization ensures that the base stations transmit the same data at the same time between the base stations is achieved using the SYNC protocol. The multicast base stations are time and phase synchronized. The radio parameters, such as modulation and coding scheme, are pre-configured for MBSFN transmissions using the MCE. This enables a multitude of base stations within the same single frequency network (SFN) area to send the exact same data, using the same radio configurations over-the-air, thereby appearing to the UE as a single transmission from a large base station. This may provide significant spectral efficiency gains, especially for cell-edge users, from using SFN as compared to uncoordinated transmissions, due to a distributed architecture and limiting the interference within the network.

Due to the extensive configuration requirements of MBSFN and the better applicability for wide-area broadcast, a simpler single cell—point-to-multipoint (SC-PTM) solution was developed in LTE. SC-PTM has been mainly designed for limited broadcast within a single cell, while taking advantage of the limited pre-configuration requirements and gains from delivering common content using multicast/broadcast, rather than unicast. SC-PTM may have a lower spectral efficiency relative to MBSFN For example, cell-edge users if the mechanism is employed in adjacent cells may experience lower spectral efficiency.

Currently, 5G Rel′15 specifications are being finalized focussing on the design principles of forward compatibility, control-user plane separation, lean and cloud-native system design. One element of the RAN design is to extend the fully distributed base station architecture to support flexible protocol functionality split between central units (CUs) and distributed units (DUs).

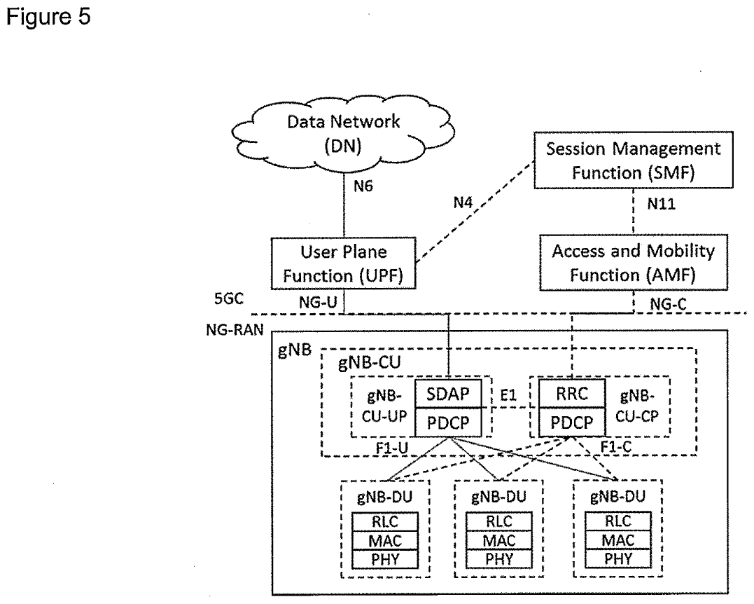

An overview of the 5G/new radio (NR) RAN architecture is shown in FIG. 5. The gNB comprises a central unit (CU) and distributed units (DU). The gNB CU includes the non-time-critical functionalities (which could be hosted on the cloud) such as: Service Data Adaptation Protocol (SDAP) which maps a QoS flow arriving from the core network into appropriate data radio bearers and Packet Data Convergence Protocol (PDCP) handling the sequence number, header compression, etc., similar to LTE.

A dynamic QoS framework in 5G enables the RAN to adapt QoS enforcement functions depending on the real-time radio conditions, which may be necessary in the context of multicast.

The DUs include real-time functionalities such as radio link control (RLC), medium access control (MAC) and physical (PHY) layer functions.

The F1 interface provides control (F1-C) and user (F1-U) plane connectivity between the CU and DU, enabling operators to deploy units from different network vendors and CIU-plane separation. The interface also provides separation between the radio network and transport network layers, while enabling the exchange of UE and non-UE associated information. The PHY layer may be further separated into higher (PHY-H possibly located in the DU) and lower layer (PHY-L) which could be hosted in a remote radio head (RRH). The interface between these layers would be the latency-critical enhanced Common Public Radio Interface (eCPRI) or xRAN interface.

The evolution from 4G to 5G may enable the mobile network and broadcast network operators to move from traditional distributed architectures to a centralized, cloud-native network, which may enable significant cost savings and time-to-market strategies. Cost savings may be achieved with the usage of low-cost hardware for base stations, with limited complexity, while centralizing the expensive and computationally intensive functions in the cloud server.

Such architecture enhancements provide an opportunity to design an improved RAN architecture for multicast content in 5G.

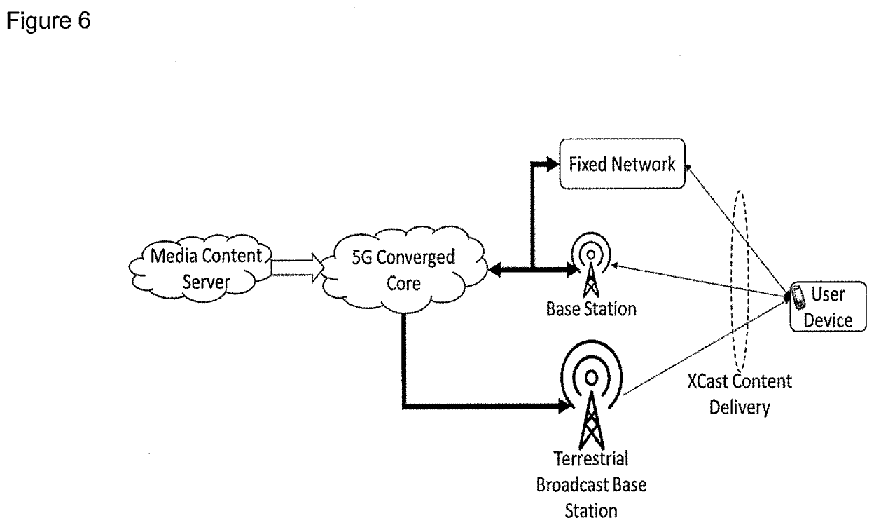

An overview of the content delivery mechanism for 5G in the context of a converged network is as shown in FIG. 6. Here Xcast content delivery indicates the radio resource efficient delivery of traffic over-the-air with an efficient mix of unicast and multicast/broadcast (which may be referred to using the term X-cast). The term multicast shall be used in the following to include multicast and broadcast.

In MBMS LTE architecture, the timing for OTA transmissions is provided using the SYNC PDU by the BM-SC located at the root of the core network, beyond the MBMS-GW. The BM-SC is time synchronized with the RAN nodes. The OTA radio parameters for MBSFN are configured statically by the Multicell/Multicast Coordination Entity (MCE). This may limit the ability of the network to consider the dynamic nature of the RAN, with varying link conditions due to mobility and radio propagation dynamics. Due to this, the MBMS service provisioning is static, with the radio reservation within the RAN enabled using guaranteed bit rate (GBR) bearers.

As a result, MBSFN is deployed with careful cell planning with static SFN areas. Dynamic setup and provisioning of multicast/broadcast traffic over a configurable area is not considered. The SFN area or the radio transmission parameters may not be dynamically modified, depending on, e.g., a change in user distribution.

While SC-PTM provides some level of flexibility in terms of dynamic multicast/broadcast content delivery, the spectral efficiency that may be achieved through coordinated transmissions with a geographic area may be lost Thus, both MBSFN and SC-PTM may be improved upon in terms of radio resource efficiency due to the lack of flexibility in the system.

The static nature of the legacy architecture and solutions in the market have limited the technology adoption, since mobile network operators and device vendors may be reluctant to implement the feature. The current system design may also be incompatible with the dynamic QoS framework in 5G, where QoS enforcement is performed in the RAN rather than in the core network.

The focus area in this topic so far has been the use of BM-SC for achieving content synchronization within the RAN through the usage of SYNC protocol.

Enhancements required for service continuity within an MBMS network, with counting and possibly localized MBMS service delivery have been considered.

In a further proposal, an MBMS bearer fault management mechanism has been proposed, based on the existing architecture and procedures for LTE. The SYNC protocol may impose challenges during erroneous operations, which may require complex management procedures.

A synchronization procedure for MBMS based on the LTE eMBMS architecture has also been described, with the usage of BM-SC and configurations in the RAN for achieving synchronization.

Means for dynamic delivery of multicast/broadcast content through enhancements in RAN for achieving OTA transmission synchronization, are provided in the following.

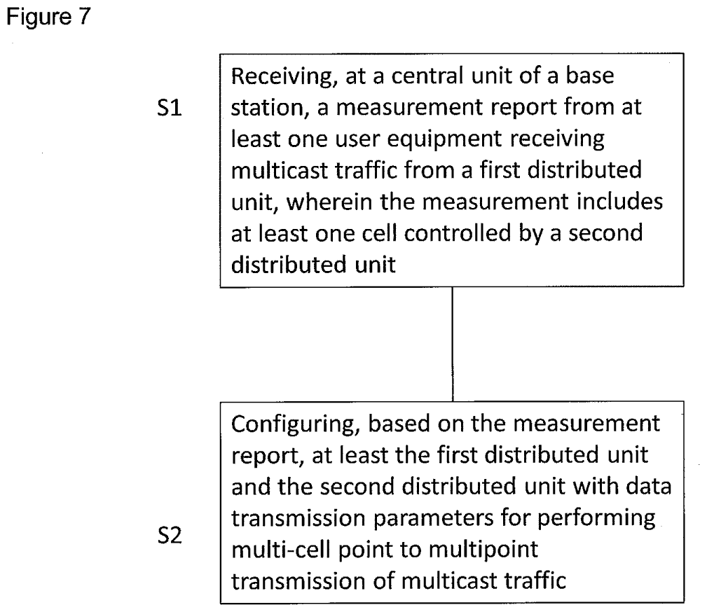

FIG. 7 shows a flowchart of a method according to an embodiment. In a first step, S1, the method comprises receiving, at a central unit of a base station, a measurement report from at least one user equipment receiving multicast traffic from a first distributed unit, wherein the measurement includes at least one cell controlled by a second distributed unit.

In a second step, S2, the method comprises configuring, based on the measurement report, at least the first distributed unit and the second distributed unit with data transmission parameters for performing multi-cell point to multipoint transmission of multicast traffic.

A method, which may be performed at a first distributed unit, comprises providing, to a central unit of a base station, a measurement report from at least one user equipment receiving multicast traffic from the first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

The central unit of a base station may be referred to as a gNB-CU. The first and second distributed units may be referred to as gNB-DUs. The first and second distributed units may be referred to a source gNB-DU and a target gNB-DU, respectively.

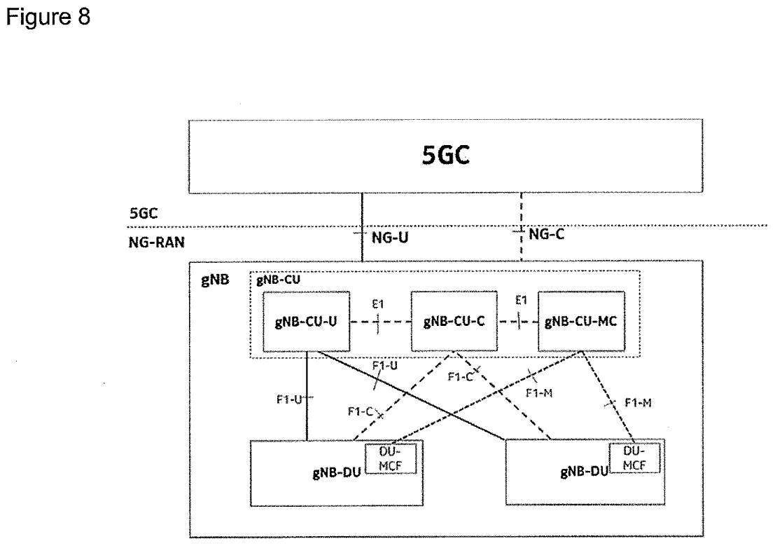

FIG. 8 shows a NG-RAN architecture according to an embodiment. The gNB includes a gNB-CU (gNB Central Unit) comprising a gNMB-CU-U (5G gNB/base station Central Unit user plane function) and a gNMB-CU-C (5G gNB/base station Central Unit control plane function)

A multicast functionality, which may be referred to as gNB-CU-MC, is provided within the 5G-gNB-CU. The multicast functionality may be used to enforce the synchronized OTA transmission of multicast/broadcast traffic within the gNB-DUs, while obeying the QoS constraints defined for the traffic flows.

The functionalities in the gNB-CU are connected via an El interface.

The NG-RAN comprises gNB-DU as described above. The gNB-CU-MC is connected to the gNB-DU via a F1-M interface. The method may comprise configuring an interface between the at least one distributed unit and a multicast functionality in the central unit. The gNB-CU-C may configure gNB-CU-MC to trigger F1-M interface setup for gNB-DUs which are in the MC-PTM list via the El interface.

The method may comprise receiving traffic at the central unit of the base station and determining that the traffic is multicast traffic based on a QoS flow identifier or a multicast context associated with the flow.

For example, the SDAP layer in gNB-CU-MC receives the multicast/broadcast traffic, and identifies the type of traffic based on the QoS flow identifier and/or through multicast context associated with the flow.

The measurement reports may be RRC neighbour cell measurement reports. The measurement objects may include the received signal strength (power or quality) values.Configuring the at least the first distributed unit and the second distributed unit may comprise adding, modifying or removing at least one of the first distributed unit and the second distributed unit from a list of distributed units for performing multi-cell point to multipoint transmission of multicast traffic.

For multicast traffic, the gNB-CU-C (which is the control plane function of the 5G gNB/base station centralized unit), based on the RRC neighbor cell measurement reports from the UEs receiving the traffic may dynamically configure(add/modify/remove) the gNB-DUs within the multi-cell point-to-multipoint (MC-PTM) list.

The method may comprise determining spectral efficiency of performing multi-cell point to multipoint transmission of multicast traffic using the second distributed unit and determining to configure the second distributed unit based on the determined spectral efficiency. In an example, configuring the gNB-DUs is based on the estimated gains in cell-edge spectral efficiency experienced by the users, if the traffic is delivered using MC-PTM compared with if the traffic is delivered independently.

The method may comprise providing a request to at least one of the first distributed unit and the second distributed unit to disable link adaptation.

In an example, a MC-PTM Setup request may comprise a request through F1-C to disable link adaptation (LA) and/or report transmission parameters for an Xcast transport channel (XTCH). Transmission parameters may include the modulation and coding scheme (MCS), TX mode, multiple input multiple output (MIMO) configuration, downlink/DL coordination information—which could also include physical resource block (PRB): fixed or list of starting PRBs for PDUs with sequence numbers),

The F1-U interface may be modified to include a new RAN-SYNC (R-SYNC) protocol enhancement.

For broadcast traffic, the SDAP may map the flows into broadcast data radio bearer (B-DRB) or Xcast radio bearer (XRB) with appropriate signaling information for broadcast. The bearers may then be broadcast using the broadcast channels by the appropriate set of gNB-DUs. The appropriate set of gNB-DUs may be determined based on the area where the data needs to be broadcast.

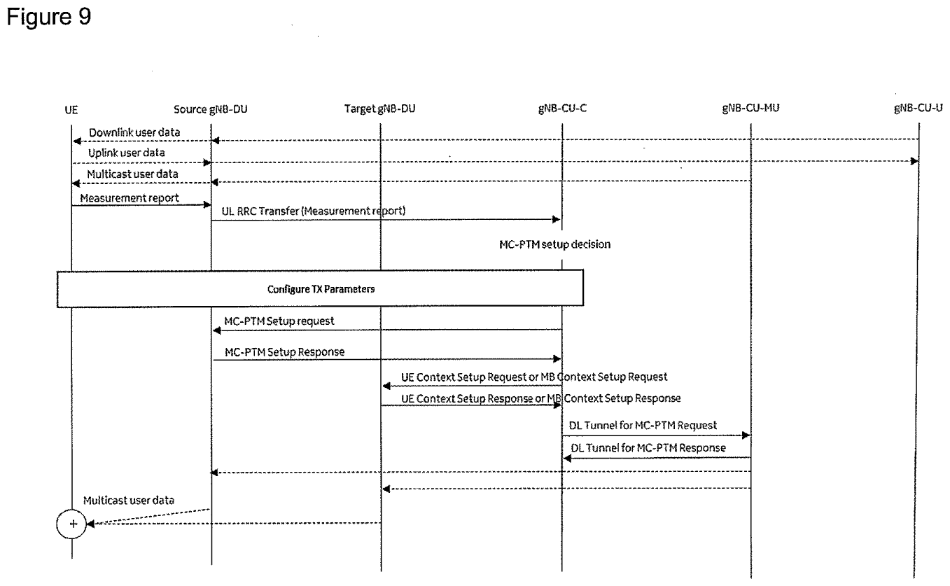

FIG. 9 shows a message flow in first scenario when first when a MC-PTM session is setup with a neighbour cell which is initially not serving the multicast/broadcast traffic.

The gNB-CU-C determines to setup MC-PTM transmission. In the decision process, the gNB-CU-C may consider, e.g., measurement reports, the number of UEs reporting the same neighbour cell(s).

The measurement reports may be the typical measurements configured for mobility (e.g. LTE RRC A3 event—Neighbour becomes offset better than PCell/PSCell).

It may be beneficial if the gNB-CU-C configures UEs receiving multicast to report neighbour cells earlier than in a typical mobility scenario. This may be achieved, for example, by configuring a lower offset for A3 event for UEs receiving multicast than the offset typically used in the cell. Alternatively, the gNB-CU-C may configure the UEs to report a neighbour cell if the neighbour cell becomes better than a threshold so that the UEs will enter A4 event (Neighbour becomes better than threshold) early enough.

For example, the gNB-CU-C may initiate the setup of MC-PTM transmission when the following formula is satisfied for at least N UE

MnᵢMp−Offset,

where Mn is the measurement result of a neighbour cell “i”, Mp is the measurement result of the PCell/PSCell (assuming that the multicast is transmitted in PCellfPSCell) and Offset represent an offset below which the neighbour cell contribution to multi-cell transmission is considered negligible as well as estimated gains in spectral efficiency. For example, the offset could be selected to correspond to 6dB difference between the received powers measured for the serving cell and the neighbour cell.

A method may comprise receiving control transmission parameters from the first distributed unit; and providing the control transmission parameters to the second distributed unit.

In an example step, the gNB-CU-C configures the target gNB-DU with the source gNB-DU transmit (TX) parameters, including the transmit power, reference signal configurations and possible subframes for multi-cell multicast transmissions. This enables the source and target gNB-DUs to transmit the same data using the same physical radio resources, reference signal configurations, etc., thereby appearing as a single transmission to the UE.

The QoS values for the multicast transmissions provided to the radio access network (RAN) by the 5G core network, combined with the radio transmit parameter information, would provide the target gNB-DU with the ability to schedule the transmissions synchronously with the source DU.

Due to the absence of cell-specific reference signals in 5G/NR, this may be achieved within the RAN as described herein.

A method may comprise receiving the data transmission parameters and/or control transmission parameters from the first distributed unit. The method may comprise providing the control transmission parameters to the second distributed unit. The source gNB-DU may report the currently used TX parameters in MC-PTM Setup Response message

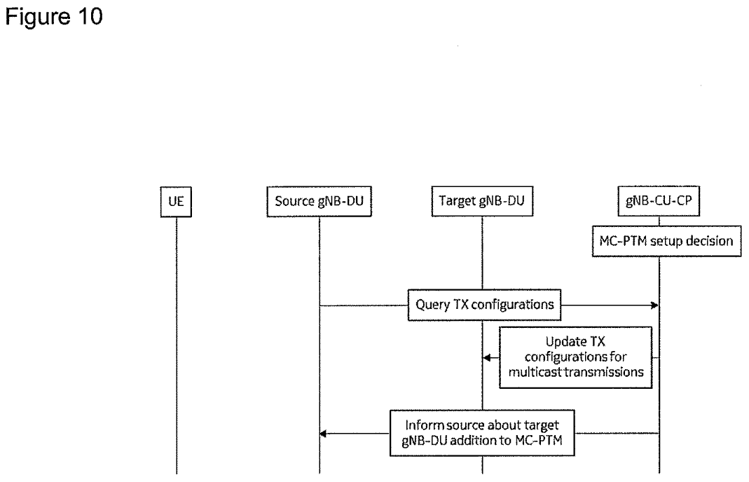

An exemplary embodiment for the possible signalling flow for the TX parameter configuration for control transmission is shown in FIG. 10. The gNB-CU-C may query the source gNB-DU to obtain TX configuration currently used for multicast transmission if the TX configuration is not known to the gNB-CU-C already. The gNB-CU-C configures the target gNB-DU with the appropriate TX parameter configuration.

After configuring the target DU with the appropriate TX parameter configurations, the CU-C may signal the source DU about the addition, in order to avoid possible change in transmit parameter configurations due to the reduced interference experienced by the cell-edge users due to the addition of target DU (which essentially turns the dominant interference into useful signal). The target DU participates in control transmission and UEs receiving multicast traffic may be configured to measure channel state considering the neighbour cell contribution to multi-cell transmission. The UEs report channel state information to the source gNB-DU. This may minimize the need for any pre-configurations or multicast specific MDT measurements in order to setup the MC-PTM, while distributing the synchronized transmissions.

The gNB-CU-C sends DL tunnel information for MC-PTM operation for one or more multicast bearers (XRBs). The existing F1-M tunnel may be unicast or multicast tunnel, e.g. GTP-U over IP multicast as used in M1 interface of eMBMS.

The gNB-CU-MU replies with the DL Tunnel for MC-PTM Response message to acknowledge the successful establishment of tunnels for the requested radio bearers. In the case when the existing tunnel is a unicast tunnel, the tunnel may be modified to a multicast tunnel (nowshown in FIG. 9). The modification of existing tunnel may also be needed if OTA synchronization is not provided using the tunnel (not shown in FIG. 9). The modification of existing tunnel is not needed if the existing tunnel at F1-M interface is using a multicast tunnelling and provides OTA synchronization information.

The gNB-CU-C initiates the MC-PTM setup by sending the MC-PTM Setup Request message. The message may include information about new/modified DL tunnel and/or TX configuration.

The source gNB-DU responds with the MC-PTM Setup Response message, which may include scheduling information (e.g. PRB pattern), data transmission configuration information (e.g. modulation and coding scheme, transmission mode). The source gNB-DU may decide on the data transmission configuration information (e.g. data transmission parameters) based on the channel state information reported by UEs receiving multicast traffic. The source gNB-DU may include one or more sets of data transmission information, e.g. to reflect the difference in data transmission configuration before and after the target gNB-DU participated in control transmission, in the MC-PTM Setup Response message, which can be used by the gNB-CU to decide whether to continue or cancel the ongoing configuration for multi-cell transmission. Upon reception of the MC-PTM Setup Request message, the source gNB-DU disables link adaptation for the multicast transmissions and schedules the multicast transmissions according to the scheduling information and OTA synchronization information received from the gNB-CU-MU and applies the TX parameter configuration and data transmission configuration information. The source gNB-DU may not apply the data transmission configuration and disable link adaptation immediately but in an MC-PIM update time (e.g. a subframe number), which can be provided by the gNB-CU-C in the MC-PTM Setup Request message, so that both the source and the target gNB-DU apply the data transmission configuration at the same time.

The gNB-CU-C requests the target gNB-DU to setup up a context. The gNB-CU-C may select one UE receiving the multicast, which could be one of the UEs that reported the neighbour cell under the target gNB-DU, but may be any UE receiving the multicast, and sends the UE Context Setup request message. The UE Context Setup message includes at least one or more of the following: a list of XRBs with corresponding DL tunnel information, the TX parameters configuration and data transmission parameters (RLC, MAC, PHY), scheduling information for each XRB an MC-PTM update time (e.g. a subframe number) when the target gNB-DU shall apply the data transmission parameters and start MC-PTM transmission. The UE Context Setup message does not include SRBs or DRBs as the target gNB-DU is not going to be serving UE's unicast.

The target gNB-DU sets up the F1-M tunnel. The procedure shown on FIG. 9 assumes that F1-M uses multicast tunnelling. In case when FI-M tunnel uses unicast tunnelling, the target gNB-DU needs to allocate DL tunnel end-point and provide the tunnel information to the gNB-CU-C in the UE Context Setup Response message. The gNB-CU-C forwards the tunnel information to gNB-CU-MU.

Another alternative is to introduce a multicast/broadcast context and related procedures over F1 and E1 reference points, which are not associated with any UE (see MB Context Setup Request/Response on FIG. 9). The multicast/broadcast context would hold information about multicast QoS flow(s) and multicast/broadcast bearer(s) and would be associated, for example, with a multicast group (e.g. IP multicast group). The content of the MB Context Setup Request/Response would similar to that described for the UE Context Setup Request/Response, except that an identity of multicast group would be used instead of UE identities.

At this point, the source and the target gNB-DU use the same configuration for multicast transmission, share the scheduling information and receive OTA synchronization information from gNB-CU-MC, which allows the source and target gNB-DU to perform the synchronous transmission.

The method described with reference to FIGS. 7 to 10 may enable the RAN to setup MC-PTM sessions without any information from the core network, similar to the SYNC protocol in LTE, which allows greater flexibility for RAN-based Xcast transmissions in 5G.

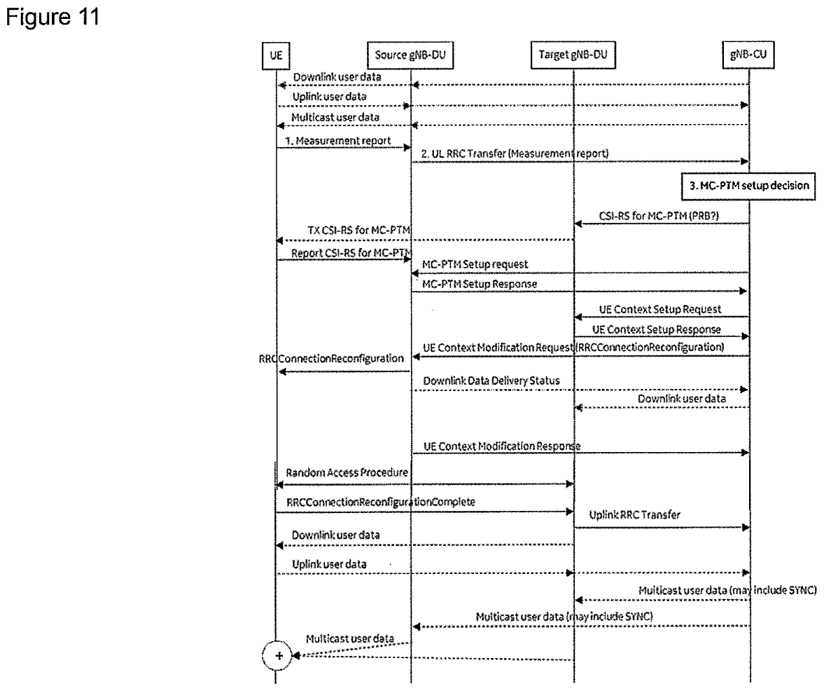

In a second scenario, neighbour cell already has an established multicast session, but is not part of multicell transmissions. FIG. 11 shows a message flow for a MC-PTM setup with a neighbour cell as part of intra-DU mobility.

The signalling diagram for the proposed RAN-based synchronization for multicast I broadcast traffic is as shown in FIG. 11. Here the gNB-CU initially configures multicast sessions with the appropriate gNB-DUs, which then schedules the traffic using the best possible/spectrally-efficient transmission mode—using unicast if there only a limited number of users, and using multicast if there are sufficiently large number of users receiving the traffic. As part of the normal operation of the UEs, they are configured to measure neighbour cells for mobility, and send the RRC measurement reports to the gNB-DUs in case the reporting criteria are satisfied as per the measurement configuration. gNB-DUs forward these RRC measurement reports as part of the UL RRC Transfer message to the gNB-CU.

The RRC in gNB-CU-C decides the need for setting up MC-PTM in terms of the relative gains for the cell-edge user spectral efficiency from the multi-cell synchronized transmissions. The CSI-RS configuration for MC-PTM transmissions could be configured by the gNB-CU in case the target gNB-DU is added to the MC-PTM. The UE reports the CSI-RS measurements of the target gNB-DU to the source gNB-DU, while the gNB-CU sends the MC-PTM setup request to the source gNB-DU and to the gNB-CU-MC, to be added to the synchronized MC-PTM group. This enables the UEs at the cell-edge to receive synchronized MC-PTM transmissions from the source and target DU, thereby improving the spectral efficiency.

In case the gNB-CU decides to handover the UE to the target cell, regular handover procedure is initiated during this time, in order to enable seamless delivery of the unicast traffic for the UE.

A method as described herein may enable synchronized transmissions within the 5G cloud-RAN in a simple, efficient and distributed manner, while taking into account the design principles and architectural elements of 5G. The setup of synchronized multicast transmissions from a multitude of cells, may improve the cell-edge spectral efficiency.

A method as described above may provide dynamic RAN based synchronization, which leads to significantly improved resource efficiency, and flexible network operation. The method may enable dynamic and zero-touch network management.

The method may be implemented in a user equipment as described with reference to FIG. 2 or a control apparatus as described with reference to FIG. 3. An apparatus may comprise means for receiving, at a central unit of a base station, a measurement report from at least one user equipment receiving multicast traffic from a first distributed unit, wherein the measurement report includes at least one cell controlled by a second distributed unit and configuring, based on the measurement report, at least the first distributed unit and the second distributed unit with data transmission parameters for performing multi-cell point to multipoint transmission of multicast traffic.

Alternatively, or in addition, an apparatus may comprise means for providing, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

The apparatus may comprise the first distributed unit.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to 5G, similar principles can be applied in relation to other networks and communication systems where a RAN or other types of access networks comprises of centralized and distributed units. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more—computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more embodiments with any of the other embodiments previously discussed.

1. An apparatus, said apparatus comprising means for:
receiving, at a central unit of a base station, a measurement report from at least one user equipment receiving multicast traffic from a first distributed unit, wherein the measurement report includes at least one cell controlled by a second distributed unit; and
configuring, based on the measurement report, at least the first distributed unit and the second distributed unit with data transmission parameters for performing multi-cell point to multipoint transmission of multicast traffic.

2. An apparatus according to claim 1, comprising means for:
receiving a traffic flow at the central unit of the base station;
determining that the traffic flow is multicast traffic based on a QoS flow identifier or a multicast context associated with the traffic flow.

3. An apparatus according to claim 1, wherein means for configuring at least the first distributed unit and the second distributed unit comprises means for adding, modifying or removing at least one of the first distributed unit and the second distributed unit from a list of distributed units for performing multi-cell point to multipoint transmission of multicast traffic.

4. An apparatus according to claim 1, comprising means for determining spectral efficiency of performing multi-cell point to multipoint transmission of multicast traffic using the second distributed unit; and
determining to configure the second distributed unit based on the determined spectral efficiency.

5. An apparatus according to claim 1, comprising: means for receiving the data transmission parameters from the first distributed unit.

6. An apparatus according claim 1, wherein the data transmission parameters include at least one of modulation and coding scheme, time and frequency scheduling information.

7. An apparatus according to claim 1, comprising means for receiving control transmission parameters from the first distributed unit; and providing the control transmission parameters to the second distributed unit.

8. An apparatus according to claim 7, wherein the control transmission parameters comprise at least one of transmit power, reference signals and time and frequency allocation.

9. An apparatus according to claim 1 comprising means for configuring an interface between first distributed unit or the second distributed unit and a multicast functionality in the central unit.

10. An apparatus according to claim 1, comprising means for providing a context setup request to the second distributed unit.

11. An apparatus according to claim 10, wherein the context setup request is a UE context setup request or a multicast context request.

12. An apparatus according to claim 1, comprising means for providing a request to at least one of the first distributed unit and the second distributed unit to disable link adaptation.

13. An apparatus according to claim 1, wherein the measurement report is a radio resource control measurement report.

14. An apparatus according to claim 1, wherein the measurement object of the measurement report comprises signal strength.

15. An apparatus comprising means for providing, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

16. An apparatus according to claim 15, comprising means for: providing the data transmission parameters to the central unit.

17. An apparatus according to claim 15, wherein the data transmission parameters include at least one of modulation and coding scheme, time and frequency scheduling information.

18. An apparatus according to claim 15 comprising means for: providing control transmission parameters to the central unit for providing to the second distributed unit.

19. An apparatus according to claim 18, wherein the control transmission parameters comprise at least one of transmit power, reference signals and time and frequency allocation.

20. (Currently Amended An apparatus according to claim 15 comprising means for configuring an interface between the apparatus and a multicast functionality in the central unit.

21. An apparatus according to claim 15, comprising means for receiving a request from the central unit to disable link adaptation; and
causing link adaptation to be disabled.

22. An apparatus according to claim 15, wherein the measurement report is a radio resource control measurement report.

23. An apparatus according to claim 15, wherein the measurement object of the measurement report comprises signal strength.

24. A method comprising:
receiving, at a central unit of a base station, a measurement report from at least one user equipment receiving multicast traffic from a first distributed unit, wherein the measurement report includes at least one cell controlled by a second distributed unit; and
configuring, based on the measurement report, at least the first distributed unit and the second distributed unit with data transmission parameters for performing multi-cell point to multipoint transmission of multicast traffic.

25. A method comprising:
providing, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

26. An apparatus comprising: at least one processor and at least one non-transitory memory including a computer program code, the at least one non-transitory memory and computer program code configured to, with the at least one processor, cause the apparatus at least to:
receive, at a central unit of a base station, a measurement report from at least one user equipment receiving multicast traffic from a first distributed unit, wherein the measurement report includes at least one cell controlled by a second distributed unit; and
configure, based on the measurement report, at least the first distributed unit and the second distributed unit with data transmission parameters for performing multi-cell point to multipoint transmission of multicast traffic.

27. An apparatus comprising: at least one processor and at least one non-transitory memory including a computer program code, the at least one non-transitory memory and computer program code configured to, with the at least one processor, cause the apparatus at least to:
provide, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.

28. A computer readable medium comprising program instructions for causing an apparatus to perform at least the following:
receiving, at a central unit of a base station, a measurement report from at least one user equipment receiving multicast traffic from a first distributed unit, wherein the measurement report includes at least one cell controlled by a second distributed unit; and
configuring, based on the measurement report, at least the first distributed unit and the second distributed unit with data transmission parameters for performing multi-cell point to multipoint transmission of multicast traffic.

29. A computer readable medium comprising program instructions for causing an apparatus to perform at least the following:
providing, to a central unit of a base station, a measurement report from at least one user equipment receiving multicast traffic from a first distributed unit, wherein the measurement report includes at least one cell controlled by a second distributed unit, wherein the central unit configures, based on the measurement report, at least the first distributed unit and the second distributed unit with data transmission parameters for performing multi-cell point to multipoint transmission of multicast traffic.
